(19) United States
(12) Patent Application Publication
(10) Pub. No.: US 2009/0248836 A1
(43) Pub. Date: Oct. 1, 2009

(54) MODEM USER MANAGEMENT SYSTEM AND METHOD

(75) Inventors: ZHI-FENG ZHANG, Shenzhen City (CN); LI-HONG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/354,757

(22) Filed: Jan. 15, 2009

(30) Foreign Application Priority Data
Mar. 27, 2008 (CN) 200810300742.0

(51) Int. Cl. G06F 15/16

(52) U.S. Cl. 709/218

(57) ABSTRACT

A modem user management system is configured for managing a plurality of user terminals with different Internet protocol (IP) addresses and users associated with different groups in a communication network. The system receives an IP address of one of the user terminals and a group type of the user of the user terminal and compares the IP addresses to determine whether the user terminal belongs to a local area network of the communication network. The system further determines whether the user is associated with an administrative group and activates an administrative interface of the modem user management system for a user upon receiving the proper login privileges.

### BACKGROUND

1. Technical Field

Embodiments of the present disclosure relate to user management systems and methods, and particularly, to a modem user management system and method.

2. Description of Related Art

People install various types of modems to connect computers and telephones to transmit data and voice. However, modems are usually very simple and may not be able to manage a plurality of user terminals with different Internet protocol (IP) addresses and users associated with different groups.

In view of the foregoing, it is desirable to provide a system and a method for overcoming the aforementioned problem.

### BRIEF DESCRIPTION OF THE DRAWINGS

FIG. 1 depicts a block diagram of one exemplary embodiment of a modem user management system of the present disclosure.

FIG. 2 depicts a flowchart of one exemplary embodiment of a user management method of the present disclosure.

### DETAILED DESCRIPTION

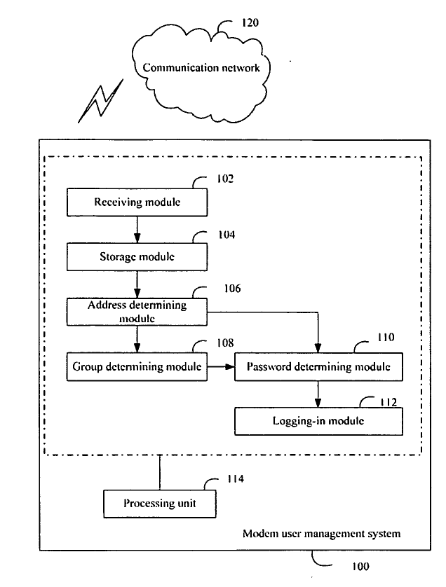

Referring to FIG. 1, a block diagram of one exemplary embodiment of a modem user management system 100 is shown. The system 100 may be embodied in a modem to manage a plurality of user terminals (hereinafter “terminals”) with different Internet protocol (IP) addresses and users. In one embodiment, the terminals may indicate a network device, such as a computer or a telephone, that is connected to the modem. IP addresses of the terminals indicate the IP addresses of the network devices used by the users. Each user is associated with a group, such as an administrative group or a common user group. Each group has different authoritative privileges through different interfaces as will be explained in further detail below. In one embodiment, an administrative interface for the administrative group has more authoritative privileges than a common user interface for the common user group. These authoritative privileges may include, but are not limited to access privileges, read and write privileges, and various administrative privileges, for example.

The system 100 includes a receiving module 102, a storage module 104, an address determining module 106, a group determining module 108, a password determining module 110, a log-in module 112, and a processing unit 114.

The receiving module 102 is configured for receiving an IP address of one of the terminals and a group type of a user of the terminal. In one embodiment, the user inputs the IP address of the terminal to the receiving module 102 via a user interface (UI). In one embodiment, the UI may be manipulated by a web-based interface. The web-based interface may be accessible over a communication network 120, such as the Internet, a local area network (LAN), or a wide area network (WAN), for example.

The storage module 104 is configured for storing an IP address range of a LAN and the IP address of the terminal received by the receiving module 102.

The address determining module 106 is configured for checking the IP address of the terminal against the IP range to determine whether the terminal belongs to the LAN. In one embodiment, if the IP address of the terminal does not belong to the LAN, the terminal belongs to a WAN.

The receiving module 102 is further configured for receiving input of the user via the UI identifying which group the user is associated with, for example, the administrative group or the common user group. The group determining module 108 is configured for determining whether the user belongs to the administrative group.

The storage module 104 is further configured for storing an administrator's name and password table and a common user's name and password table.

The receiving module 102 is further configured for receiving the administrator's and the common user's name and password input to verify if the user is authorized to use the system 100. In one embodiment, the receiving module 102 receives the administrator's name and password and the common user's name and password via the UI. In one embodiment, the UI is the web-based interface.

The password determining module 110 is configured for determining whether the user is authorized to use the modem user management system 100 by checking whether a name and a password received by the receiving module 102 matches entries in the corresponding name and password table read from the storage module 104. In one embodiment, if the user belong to the administrative group determined by the group determining module 108, the password determining module 110 reads the administrator's name and password table stored in the storage module 104. Otherwise, the password determining module 110 reads the common user's name and password table.

The log-in module 112 is configured for activating an administrative interface of the modem user management system 100 upon the condition that the terminal belongs to the WAN and the user belongs to the administrative group. The log-in module 112 is further configured for activating a common user interface of the modem user management system 100 upon the condition that the terminal does not belong to the LAN or the user does not belong to the administrative group.

The processing unit 114 is configured for executing one or more operations for the receiving module 102, the storage module 104, the address determining module 106, the group determining module 108, the password determining module 110, and the log-in module 112. In one embodiment, the processing unit 114 is a central processing unit (CPU).

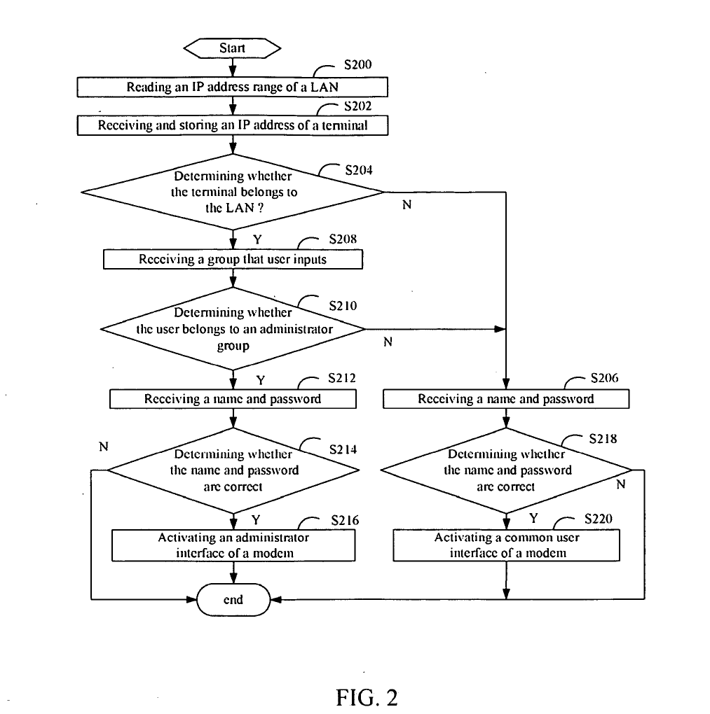

FIG. 2 depicts a flowchart of one exemplary embodiment of a user management method of the present disclosure. In one embodiment, the user management method employed by a modem is accomplishment by the function modules shown in FIG. 1.

In block S200, the address determining module 106 reads an IP address range of a LAN.

In block S202, the receiving module 102 receives an IP address of a terminal on a communication network 120 used by a user. Accordingly, the storage module 104 stores the IP address of the terminal. As mentioned above, the communication network 120 may be a LAN and/or a WAN.

In block S204, the address determining module 106 determines whether the terminal on the communication network 120 belongs to the LAN by comparing the IP address of the terminal with the IP address range of the LAN. If the address of the terminal is part of the range belonging to the LAN, the flow goes to block S208. Otherwise, the IP address belongs to a WAN and the flow goes to block S206.

In block S208, the receiving module 102 receives user input declaring which group the user belongs to. In one embodiment, the user inputs group via a UI, and as mentioned above, the UI may be manipulated by a web-based interface. The web-based interface may be accessible over a communication network 120, such as the Internet, a LAN, or a WAN, for example.

In block S210, the group determining module 108 determines whether the user belongs to the administrative group. If the user belongs to the administrative group, the flow goes to block S212. If the user does not belong to the administrative group, the flow goes to block S206.

In block S212, the receiving module 102 receives the user's name and password. In one embodiment, the user's name and password indicates the administrator's name and password. The user inputs the administrator's name and password via the UI as mentioned above.

In block S214, the password determining module 110 determines if the user's name and password are correct. In one embodiment, the password determining module 110 compares the user's name and password received by the receiving module 102 with the administrator's name and password table stored in the storage module 104. If there is a match, the flow goes to block S216. If there is no match, the flow ends.

In block S216, the log-in module 112 activates the administrative interface of the modem.

If the terminal does not belong to the LAN as determined in block S204 or the user does not belong to the administrative group as determined in block S2 10, the flow goes to block S206. In block S206, the receiving module 102 receives the user's name and password. In one embodiment, the user's name and password indicates the common user's name and password. The user inputs the common user's name and password via the UI as mentioned in block S212.

In block S218, the password determining module 110 determines whether the user's name and password are correct. In one embodiment, the password determining module 110 compares the user's name and password received by the receiving module 102 with the common user's name and password table stored in the storage module 104. If there is a match flow goes to block S220. If there is no match, the flow ends.

In block S220, the log-in module 112 activates the common user interface of the modem.

The description of the present disclosure has been presented for purposes of illustration and description, and is not intended to be exhaustive or limited to the disclosure in the form disclosed. Many modifications and variations will be apparent to those of ordinary skill in the art. Various embodiments were chosen and described in order to best explain the principles of the disclosure, the practical application, and to enable others of ordinary skill in the art to understand the disclosure for various embodiments with various modifications as are suited to the particular use contemplated.

What is claimed is:

1. A modem user management system for managing a plurality of user terminals with different Internet protocol (IP) addresses and users associated with different groups in a communication network, comprising:
a receiving module configured for receiving an IP address of a user terminal from the plurality of user terminals and a group that is associated with a user of the user terminal, wherein the group comprises an administrative group and a common user group, and wherein the administrative group and the common user group have different authoritative privileges;
an address determining module configured for checking the IP address of the user terminal against an IP address range of a local area network (LAN) of the communication network to determine whether the user terminal belongs to the LAN;
a group determining module configured for determining whether the user is associated with the administrative group based on the group received by the receiving module;
a log-in module configured for activating an administrative interface of the modem user management system upon the condition that the user terminal belongs to the LAN and the user is associated with the administrative group; and
a processing unit that executes the receiving module, the address determining module, the group determining module, and the log-in module.

2. The modem user management system as claimed in claim 1, further comprising a storage module configured for storing the IP address range of the LAN and the IP address of the user terminal.

3. The modem user management system as claimed in claim 1, wherein the receiving module is further configured for receiving a user's name and password.

4. The modem user management system as claimed in claim 3, further comprising a password determining module configured for determining whether the user is authorized to use the modem user management system.

5. The modem user management system as claimed in claim 1, wherein the log-in module is further configured for activating a common user interface of the modem user management system that has different authoritative privileges from the administrative interface of the modem user management system upon the condition that the user terminal does not belong to the LAN.

6. The modem user management system as claimed in claim 1, wherein the log-in module is further configured for activating a common user interface of the modem user management system upon the condition that the user is not associated with the administrative group.

7. A user management method employed by a modem for managing a plurality of user terminals with different Internet protocol (IP) addresses and users associated with different groups in a communication network, the user management method comprising:
receiving an IP address of a user terminal in the communication network used by a user;
checking the IP address of the user terminal against an IP address range of a local area network (LAN) of the communication network to determine whether the user terminal belongs to the LAN;
receiving a group type that is associated with the user of the user terminal if the user terminal belongs to the LAN;
determining whether the user is associated with an administrative group based on the group type; and
activating an administrative interface of the modem if the user is associated with the administrative group.

8. The user management method as claimed in claim 7, further comprising:
receiving the user's name and password;
determining whether the received user's name and password are correct; and
activating the administrative interface of the modem if the user's name and password are correct.

9. The user management method as claimed in claim 7, further comprising;
determining that the user terminal belongs to a wide area network (WAN) if the user terminal does not belong to the LAN;
receiving the user's name and password;
determining whether the user's name and password are correct; and
activating a common user interface of the modem if the user's name and password are correct.

10. The user management method as claimed in claim 9, further comprising:
determining that the user associates with a common user group if the user does not belong to the administrative group;
receiving the user's name and password;
determining whether the user's name and password are correct; and
activating a common user interface of the modem if the user's name and password are correct.
